(19) United States
(12) Patent Application Publication
(10) Pub. No.: US 2013/0061147 A1
(43) Pub. Date: Mar. 7, 2013

(54) METHOD AND APPARATUS FOR DETERMINING DIRECTIONS AND NAVIGATING TO GEO-REFERENCED PLACES WITHIN IMAGES AND VIDEOS

(71) Applicant: Jarome Beaurepaire, Berlin (DE)

(72) Inventor: Jarome Beaurepaire, Berlin (DE)

(73) Assignee: Nokia Corporation, Espoo (FI)

(21) Appl. No.: 13/226,942

(22) Filed: Sep. 7, 2011

(51) Int. Cl. G06F 3/01; G06F 15/16

(52) U.S. Cl. 715/738

(57) ABSTRACT

An approach is provided for determining directions and navigating to geo-referenced places within images and videos. A location platform causes, at least in part, a selection of one or more elements depicted in one or more images. The location platform then causes, at least in part, an identification of the one or more elements, the one or more images, or a combination thereof. Next, the location platform causes, at least in part, a transmission of the identified one or more elements, the identified one or more images, or a combination thereof for use by a device.

### BACKGROUND

Service providers (e.g., wireless, cellular, etc.) and device manufacturers are continually challenged to deliver value and convenience to consumers by, for example, providing compelling network services. One area of development has been the integration of location and image data to enable services to be, for instance, navigation systems. For example, navigation systems may use an image to determine location information associated with the image. However, even with the availability of associated location and image data, their use with respect to navigation has generally been limited to geo-tags of entire image files. For example, location information may be available for an entire image, but elements within the image may have specific location information distinct from that of the entire image. Accordingly, service providers and device manufacturers face significant challenges to enabling navigation to elements within an image.

### SOME EXAMPLE EMBODIMENTS

Therefore, there is a need for an approach for determining location information specific to elements within an image.

According to one embodiment, a method comprises causing, at least in part, a selection of one or more elements depicted in one or more images. The method also comprises causing, at least in part, an identification of the one or more elements, the one or more images, or a combination thereof. The method further comprises causing, at least in part, a transmission of the identified one or more elements, the identified one or more images, or a combination thereof for use by a device.

According to another embodiment, an apparatus comprises at least one processor, and at least one memory including computer program code for one or more computer programs, the at least one memory and the computer program code configured to, with the at least one processor, cause, at least in part, the apparatus to determine a selection of one or more elements depicted in one or more images. The apparatus also causes an identification of the one or more elements, the one or more images, or a combination thereof. The apparatus further causes, at least in part, a transmission of the identified one or more elements, the identified one or more images, or a combination thereof for use by a device.

According to another embodiment, a computer-readable storage medium carries one or more sequences of one or more instructions which, when executed by one or more processors, cause, at least in part, an apparatus to determine a selection of one or more elements depicted in one or more images. The apparatus also causes an identification of the one or more elements, the one or more images, or a combination thereof. The apparatus further causes, at least in part, a transmission of the identified one or more elements, the identified one or more images, or a combination thereof for use by a device.

According to another embodiment, an apparatus comprises means for causing, at least in part, a selection of one or more elements depicted in one or more images. The apparatus also comprises means for causing, at least in part, an identification of the one or more elements, the one or more images, or a combination thereof. The apparatus further comprises means for causing, at least in part, a transmission of the identified one or more elements, the identified one or more images, or a combination thereof for use by a device.

According to one embodiment, a method comprises receiving one or more images, one or more elements depicted in the one or more images, or a combination thereof, wherein the one or more images, the one or more elements, or a combination thereof are associated with identification information. The method also comprises causing, at least in part, a usage of the one or more images, the one or more elements, the identification information, or a combination thereof in a mapping application, a navigation application, a location-based application, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to receive one or more images, one or more elements depicted in the one or more images, or a combination thereof, wherein the one or more images, the one or more elements, or a combination thereof are associated with identification information. The apparatus also causes, at least in part, a usage of the one or more images, the one or more elements, the identification information, or a combination thereof in a mapping application, a navigation application, a location-based application, or a combination thereof.

According to another embodiment, a computer-readable storage medium carries one or more sequences of one or more instructions which, when executed by one or more processors, cause, at least in part, an apparatus to receive one or more images, one or more elements depicted in the one or more images, or a combination thereof, wherein the one or more images, the one or more elements, or a combination thereof are associated with identification information. The apparatus also causes, at least in part, a usage of the one or more images, the one or more elements, the identification information, or a combination thereof in a mapping application, a navigation application, a location-based application, or a combination thereof.

According to another embodiment, an apparatus comprises means for receiving one or more images, one or more elements depicted in the one or more images, or a combination thereof, wherein the one or more images, the one or more elements, or a combination thereof are associated with identification information. The apparatus also comprises means for causing, at least in part, a usage of the one or more images, the one or more elements, the identification information, or a combination thereof in a mapping application, a navigation application, a location-based application, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, 47-49, and 54-56.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining location information of elements within an image, according to one embodiment;

FIG. 2 is a diagram of the components of a location platform capable of determining location information of elements within an image, according to one embodiment;

FIG. 3 is a flowchart of a process for determining location information of elements within an image, according to one embodiment;

FIG. 4 is a flowchart of a process for rendering elements with associated location information

FIG. 5 is a diagram of a user interface for determining location information, according to one embodiment;

FIG. 6A-6B are diagrams of user interfaces utilized in the processes of FIGS. 3 and 4, according to various embodiments;

FIG. 7 is a diagram of a user interface for transferring location information from a first device to a second device, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for determining location information of elements within an image are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

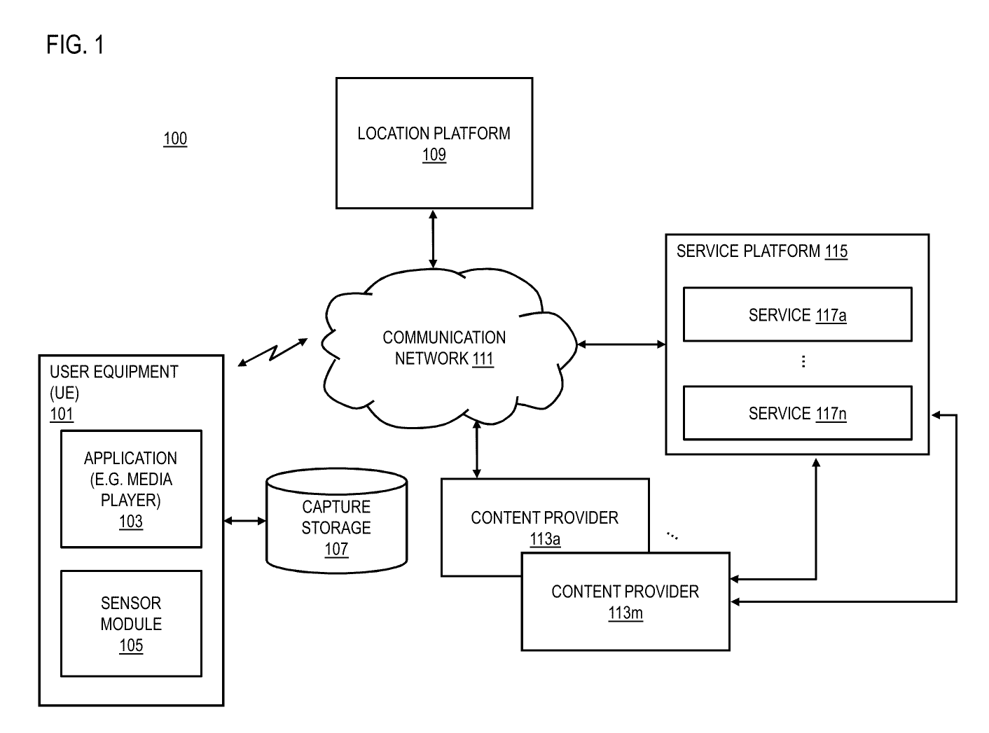

FIG. 1 is a diagram of a system capable of determining location information of elements within an image, according to one embodiment. Traditionally, entire images may be geo-tagged to provide location information for the image, but elements within the image may not have geo-tags independent of the full image. As a result, elements within the image that may be located far from where the geo-tagged image was taken, may nevertheless be tagged with geographical data that better represents the entire image, rather than the individual element. The location information of the image served as the location information for all the elements contained in the image.

To address this problem, a system 100 of FIG. 1 introduces the capability to identify elements within an image and process the elements for further information, such as location information. In this way, users no longer need to independently look for information about a point of interest in an image. Instead, a user may select a point of interest, or element, in the image, and obtain location information specific to that particular point of interest, rather than location information that pertains to the full image.

The system 100 may build on the ready availability of location information and introduce the capability to apply the availability to elements within an image. The term “image” refers to pictures, videos, renderings (e.g., augmented reality renderings, virtual reality renderings), virtual worlds, and/or any other graphical depictions of one or more locations. In one embodiment, it is contemplated that the locations can be real-world locations or virtual locations (e.g., in a virtual world such as a gaming world or other virtual reality simulation). Moreover, the images can be presented in two-dimensions or three-dimensions.

More specifically, the system 100 processes one or more images (e.g., photographs, image streams, videos, pictures, etc.) to determine various elements within an image. In one embodiment, the picture or video may be a panoramic view of a city. In this scenario, elements within the city may be buildings or other landmarks. In some embodiments, the location information of the elements are previously embedded in the image. In other embodiments, location information is determined based on further processing of the image data.

As shown in FIG. 1, the system 100 comprises a user equipment (UE) 101 having connectivity to location platform 109 via a communication network 105. The UE 101 may display, via an application 103, one or more images (e.g. pictures or videos). In one embodiment, one or more elements depicted in one or more images may be landmarks or sites within an image. For instance, in the scenario where a user is watching a television program about a city, sensor module 105 of UE 101 may permit the user to click on an element on the television screen to select the element. This element selection may then prompt location platform 109 to process the image and element data to obtain Global Positioning System (GPS) information associated with the element. In this way, the user may calculate directions (driving route, pedestrian route, etc) and then navigate to elements in pictures or videos. Alternately, in the scenario where a user is watching a travel show about a foreign city, the user may obtain more detailed information about landmarks or scenery in the show by selecting a landmark or piece of scenery as an element on the television screen. Likewise, in an exemplary situation where an image or picture is an advertisement, an interested user may retrieve locations of various elements shown in the advertisement image, such as store information, origin of the products, booking or reservation information, and/or nearby establishments.

The images may depict physical places, but they may also include virtual or computer-generated scenery. In such an embodiment, selecting an item on the screen may yield a rendering of a local map of the fictional land. For instance, while watching a fantasy movie, a user may select one or more elements to see the location of the element with respect to elements in other scenes, to map the route of characters in the movie, compare various settings depicted in the movie, or a combination thereof. Any data may be associated with the element picked once elements may be distinguished from images and associated with information independent from the image.

Sensor module 105 may detect user interaction with a user interface generated by the UE 101, application 103, and/or the location platform 109. The sensor module 105 may work in conjunction with the location platform 109, wherein the sensor module 105 identifies a point on the user interface that the user selects, such as by brushing, clicking, or touching the screen of UE 101. The location platform 109 may then correlate point(s) selected with an element within an image, and consequently, find location information associated with that element.

In a further embodiment, the location platform 109 may embed one or more elements in an image to associate the one or more elements with information such as location information. The location platform 109 may then generate a user interface that demarcates the embedded elements to better show which elements carry more detailed information. For example, the embedded elements may be highlighted so the user knows which elements have specific location information available.

In another further embodiment, the GPS information and/or detailed information may be transmitted to a portable device via the communication network 111. In one instance, the portable device may then navigate the user from his present location to the selected element using one or more navigation tools (e.g. a GPS). In this way, a user may directly receive directions to a place depicted in a picture or video without additional steps of having to enter the location data on a portable navigation device.

Moreover, the location platform 109 may receive information from the sensor module 105 on the UE 101, and store the information on capture storage 107. The capture storage 107 may include identifiers to the UE or image as well as associated information. Further, the information may be any one of multiple types of information that can provide means for creating a rendering of the information in a contact-based user interface. The capture storage 107 may store information from the sensor module 105, location platform 109, content provider 113, and/or service platform 115 as processed through the location platform 109 for the user to access at a later date.

In one embodiment, the location platform 109 may process elements, images, data, and location information obtained from the service platform 115, the services 117a-117n (also collectively referred to as services 117) of the service platform 115, and/or the content providers 119a-119m (also collectively referred to as content providers 119). By way of example, the service platform 115, the services 117, and/or the content providers 119 may include or otherwise support services (e.g., content sharing services, social network services, content stores, content databases that provide one or more of the image recognition, georeference, and/or geotagging capabilities.

By way of example, the communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, location platform 109, content provider 113, and service platform 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

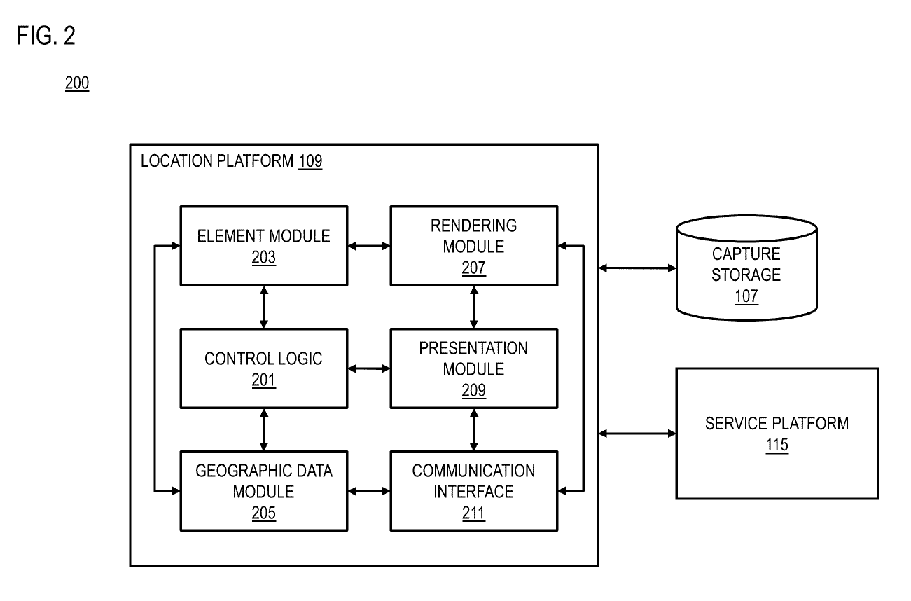

FIG. 2 is a diagram of the components of the location platform 109, according to one embodiment. By way of example, the location platform 109 includes one or more components for providing location information of elements within an image. It is contemplated that the functions of these components may be combined in one or more components or performed by other components of equivalent functionality. In this embodiment, the location platform 109 includes a control logic 201, element module 203, geographic data module 205, rendering module 207, presentation module 209, and communication interface 211.

The control logic 201 oversees tasks, including tasks performed by the element module 203, geographic data module 205, rendering module 207, presentation module 209, and communication interface 211. For example, although the other modules may perform the actual task, the control logic 201 may determine when and how those tasks are performed or otherwise direct the other modules to perform the task.

The element module 203 may work in conjunction with the sensor module 109 to determine the element selected within an image. For example, the sensor module 109 may detect a point in an image that has been selected by a user. The element module 203 may then determine an element within the image associated with the point selected by a user. In other words, sensor module 109 may recognize a user touching a screen and selecting a point comprised of a number of pixels. Element module 203 may determine that the pixels touched are associated with a given element.

The geographic data module 205 manages and controls determination of location information associated with the identified element. The geographic data module 205 may obtain this location information in a variety of ways. In one embodiment, the geographic data module 205 may employ a map application to determine the location information. For example, the geographic data module may determine a model of an element (e.g. a three-dimensional map made from a physical scan), identify the element by matching the element to the model, then determine the location information from data offered by the model. In a further embodiment, the geographic module 205 may use image recognition to identify the element chosen, and then find location information associated with the identity.

In another embodiment, the geographic data module 205 may employ a more interactive method of prompting the user to select an image tied more closely to the element. From there, geographic data module 205 may use a map application such as an online map application to determine location information of the element. More specifically, the location can be determined by a triangulation system such as a GPS system, assisted GPS (A-GPS), wireless local area network triangulation, or other location extrapolation technologies. Standard GPS and A-GPS systems can use satellites to pinpoint the location (e.g., longitude, latitude, and altitude) of the element. GPS coordinates can provide finer detail as to the location of the element.

Alternately, geographic data module 205 may determine the location information of one or more elements using a map of a city (e.g. Navteq) overlaid, and mapped to the location depicted. By matching the city map overlay with the location selected, location information may be found. In another method to determine the location information of one or more elements, locations may be pre-determined and embedded in the image data. In this method, selecting the element within an image may directly retrieve location information without employing additional steps. The possible use of the magnetometer (compass) integrated in a device can help in determining the direction the user is facing and thus helps matching the city map overlay with the location selected.

Once the element's location information has been determined by the geographic data module 205, the rendering module 207 may determine preferences from, at least in part, users, content providers 113, the service platform 115, or some combination thereof. In one embodiment, content providers 113 and/or the service platform 115 may specify that elements with associated location information be demarcated so that users can clearly see where location information is available. In one scenario, demarcation may take the form of highlighting the elements that are available for selection by the user. In a further embodiment, the rendering module 207 may work with the element module 203 to determine the portions of the image that constitute the element so that the rendering module 207 may know where to highlight the image.

The presentation module 209 may control the display of a user interface as dictated by specifications drawn from the rendering module 207. In one embodiment, the rendering module identifies preferences as to what to display, while the presentation module 209 executes the creation of a user interface in accordance with the preferences. For example, once the rendering module 207 determines portions of an image to highlight, the presentation module 209 may create the highlighted image on a user interface for the user to interact with. In another embodiment, the presentation module 209 may further create a rendering of location information as selected by the user, and possibly offer further details on location information for the user to pick.

The communication interface 211 manages and controls any incoming and outgoing communication such as image and element analysis, data sharing, receiving various requests for location information and/or renderings of the location information from other UEs 101 or the content providers 113, service platform 115, and/or the services 117. The communication interface 211 can also manage other communications of the UE 101 such as Internet communications. For example, as discussed above, the rendering module 205 may retrieve element information from the element module 203 and geographic element module 205, via the communication interface 211, in order to render images with selectable elements highlighted. The UE 101 may also be connected to storage media module such as the capture storage 111 such that the location platform 109 can access or store communication history data. By way of example, if the capture storage 111 is not local, then it may be accessed via the communication network 105.

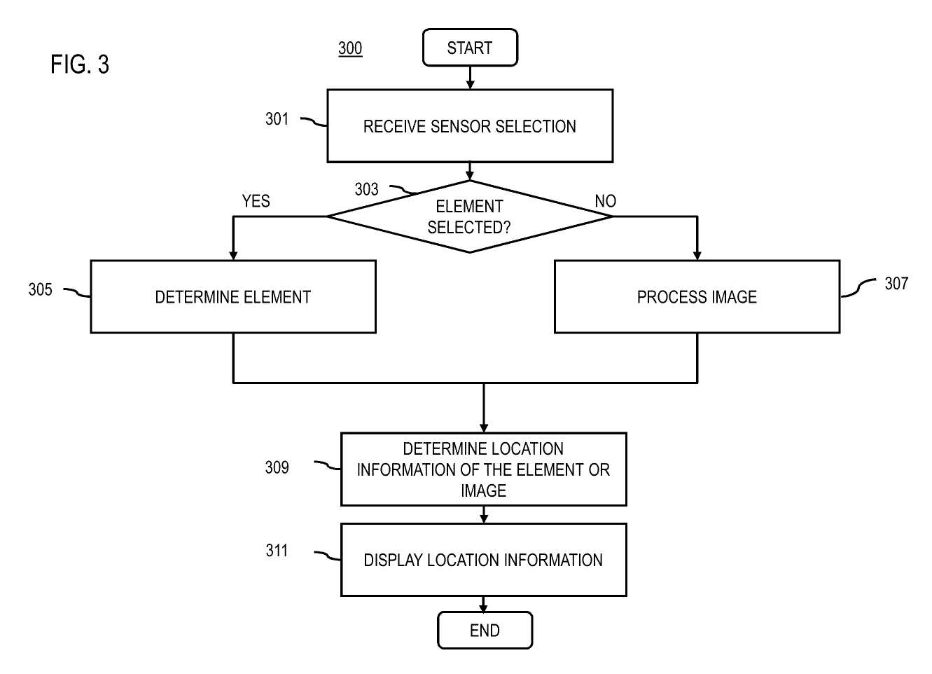

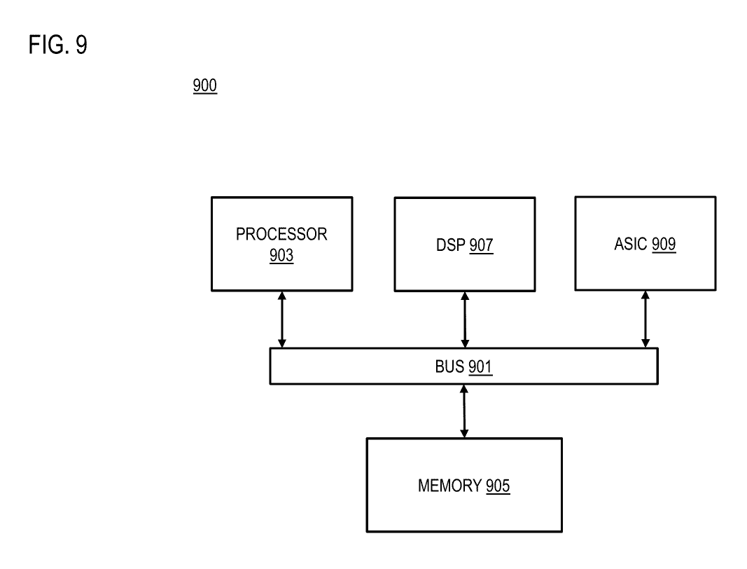

FIG. 3 is a flowchart of a process for determining location information of elements within an image, according to one embodiment. In one embodiment, the location platform 109 performs the process 300 and is implemented in, for instance, a chip set including a processor and a memory as shown in FIG. 9. In step 301, the location platform 109 processes and facilitates a processing of one or more images and sensor data received from sensor module 105 to determine, at least in part, a user selection on one or more images. In other words, the location platform 109 causes, at least in part, a selection of one or more elements depicted in one or more images. By way of example, a user may touch a user interface displaying a picture or video to make a selection. Upon receiving a user selection, the location platform 109 may detect whether the selection within the image is of an element within the image. For instance, in an image displaying a skyline view of New York City, touching the portion of the image depicting the sky may be taken as selecting the image as a whole. In return, the content provider 113, service platform 115, and/or services 117 may yield location information on New York City, N.Y. In contrast, touching the depiction of New York's Empire State Building in the image, may return the exact address of the Empire State Building.

In step 305, the element module 203 may determine one or more elements depicted in one or more images to identify whether the user has selected an element within the image. The one or more images (and in turn, elements) include, at least in part, a photograph, a video, a virtual reality display, an augmented reality display, or a combination thereof. As previously noted, the images and elements may be a two-dimensional or a three-dimensional image. Alternately, if the selection is that of an image, the location platform 109, content provider 113, service platform 115, and/or services 117 may process the image itself in place of determining the element within the image (step 307).

After causing, at least in part, an identification of the one or more elements, the one or more images, or a combination thereof, the geographic data module 205 of the location platform 109 may process and/or facilitate a processing of data associated with the one or more images, the one or more elements, or a combination thereof to determine identification information (e.g., location information, point-of-interest information, descriptive information, etc.) associated with the one or more elements (step 309). In one embodiment, the processing may include the geographic module 205 determining point of interest information associated with the one or more elements, wherein the determination of the location information is based, at least in part on the point of interest information. For example, the geographic data module 205 may access a point of interest (POI) collection or application, such as application 103, to determine location information of one or more selected elements.

In another embodiment, the geographic data module 205 may cause, at least in part, a generation of a query for the location information based, at least in part, on the point of interest information and determine to transmit the query to a location-based service, a location-based application, or a combination thereof to determine the location information. For instance, the point of interest information may include the name of an element, and initiate an internet search for the location information of the element named. As in, the point of interest information may identify an element as, “Empire State Building,” causing the geographic data module 205 to then query the internet for location information regarding the Empire State Building. In one embodiment, location information includes, at least in part, one or more geographic coordinates, address information, or a combination thereof.

Step 309 may further include the geographic data module 205 determining mapping information, navigation information, or a combination thereof based, at least in part, on the location information. In one embodiment, the location information may further be processed to determine directions and/or route information for transporting the user to the location of the selected element. In essence, process 300 is used to retrieve one or more elements depicted within one or more images, and permit users to process the element information to perform a further operation.

At step 311, the rendering module 207, presentation module 209, and/or communication interface 211 may work together to display the location information. In one embodiment, the display may include the communication interface 211 causing, at least in part, a transmission of the one or more elements, the location information, the one or more images, or a combination thereof from a first device to a second device, wherein the one or more elements, the location information, the one or more images are further processed, presented, or a combination thereof by the second device. In one embodiment, the communication interface 211 causes, at least in part, a transmission of the identified one or more elements, the identified one or more images, or a combination thereof for use by a remote device. For instance, after retrieving location information on the initial image and device, the communication interface 211 may transfer the location information to another second device (e.g. a user device or GPS) to facilitate navigation without the user having to manually enter the location information again on the second device.

In one embodiment, the identified one or more elements, the identified one or more images, or a combination thereof is for use by a mapping application, a navigation application, a location-based application, or a combination thereof of the remote device. By way of example, the identified one or more elements, the identified one or more images, or a combination thereof is for use as a destination, a waypoint, or a combination thereof by the remote device.

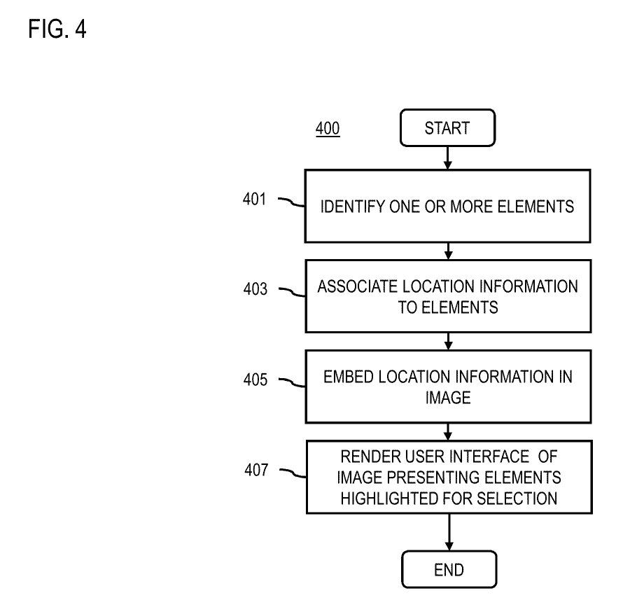

FIG. 4 is a flowchart of a process for rendering elements with associated location information. In one embodiment, the location platform 109, content provider 113, service platform 115, and/or services 117 perform the process 400 and the process is implemented in, for instance, a chip set including a processor and a memory as shown in FIG. 9. The process 400 assumes that location information has already been determined as provided by the geographic data module 205, content provider 113, service platform 115, and/or services 117.

In step 401, the element module 203 may identify one or more elements within a picture or video. For instance, the Empire State Building may be an element within an image or video of New York City. The geographic data module 205 may then determine data associated with the element in the image. In one embodiment, data associated with the image may be used to determine location information associated with the one or more elements.

In step 403, the geographic data module 205 may associate location information with the element in the image. Elements in one or more images may be tagged with location information, meaning the image or video may be regarded as a database of location information, where the location information may be extracted by selecting an element associated with the information. In this exemplary case, selecting the associated element takes place through an interactive user interface.

In step 405, the rendering module 207 may process and/or facilitate a processing of the data associated with the one or more images to cause, at least in part, an embedding of the one or more elements, the location information, or a combination thereof in the data, the one or more images, or a combination thereof. For instance, rendering module 207 may cause an image to be embedded with the location information of several elements depicted within the image.

In step 407, the presentation module 209 may cause, at least in part, a rendering of a user interface to present the one or more images, one or more representations of the one or more elements, or a combination thereof, wherein the determination of the location information is based, at least in part, on interaction information associated with the user interface. In one embodiment, location information is embedded for one or more elements within an image, and the location information presented is contingent on the element selected by a user as detected by the sensor module 105 at the user interface. In a further embodiment, the user interface includes, at least in part, a highlighting of the one or more elements for selection by a user, so that the user can easily see the elements in an image for which location information is available (step 407). In yet another further embodiment, steps 405 and 407 may comprise of determining descriptive data associated with the one or more elements, and causing, at least in part, a rendering of the descriptive data in the user interface. In one embodiment, the descriptive data may include additional facts or information about the selected element, such as historic significance or visiting hours. In some embodiments, the user interface is for enabling, at least in part, one or more touch-based interactions with respect to the one or more elements, the one or more images, or a combination thereof. For example, the touch-based interactions are for causing, at least in part, a selection of the elements or images, the identification of the elements or images, the transmission of the elements or images to a remote device, or a combination thereof.

In another embodiment, from the perspective of the remote device (e.g., a mobile device, a video display device such as a television, etc.), the remote device receives the one or more images, one or more elements depicted in the one or more images, or a combination thereof, wherein the one or more images, the one or more elements, or a combination thereof are associated with identification information. The identification information (e.g., location information, point-of-interest information, descriptive information, etc.), for instance, is determined via the process as described above.

The remote device and/or the location platform 109 can then cause, at least in part, a usage to the one or more images, the one or more elements, the identification information, or a combination thereof in, for instance, a mapping application, a navigation application, a location-based application, or a combination thereof. The elements, images, identification information, etc. can be used as destinations and/or waypoints in the applications at the remote device.

In one embodiment, the remote device can cause, at least in part, a rendering of a user interface to present the one or more images, the one or more elements, the identification information, or a combination thereof, wherein the usage in the mapping application, the navigation application, the location-based, application, or a combination thereof is based, at least in part, on interaction information associated with the user interface. For example, the user interface can depict the elements or images and enable the user to use touch-based interactions to drag the element or images to the mapping, navigation, or other location-based application for use. This dragging can then initiate the application to begin mapping, navigating, etc. to the location information associated with the elements, the images, the identification information, etc.

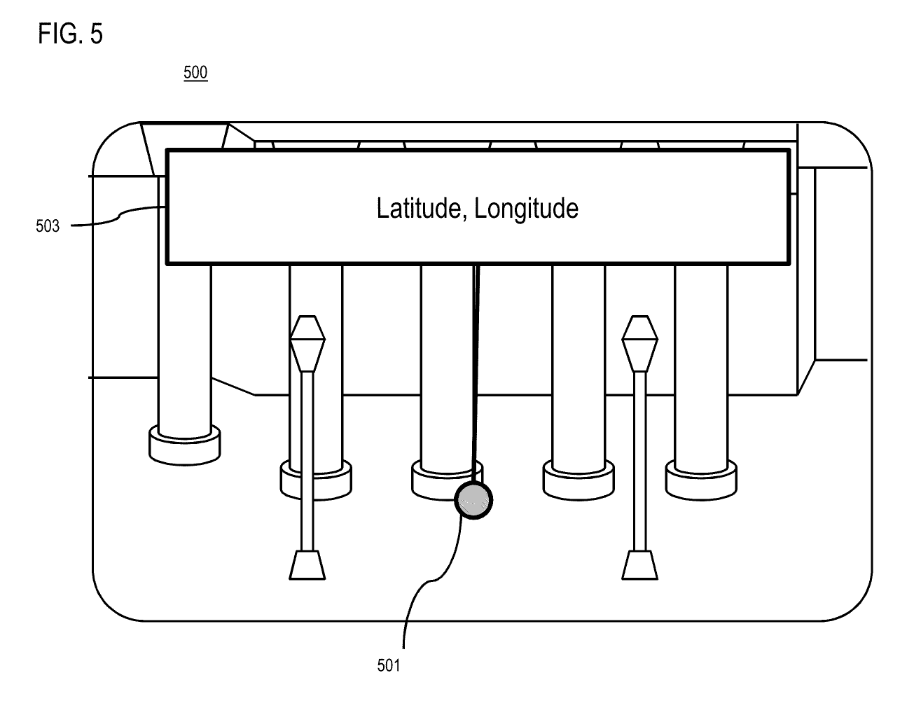

FIGS. 5-7 are diagrams of user interfaces utilized in the processes of FIGS. 3 and 4, according to various embodiments. In FIG. 5, user interface 500 is a sample display in which each pixel or point 501 on the user interface may be selected for location information. In one example user interface, caption 503 may display the location information, such as latitude and longitude. In this way of using Navteq scanning, elements within a picture are not limited to outdoor locations, as captured by aerial scans, for instance. Instead, elements may include, at least in part, indoor structures and locations as well. As shown in FIG. 5 with caption 503, every single point 501 then has associated location information specific to that point 501 in space.

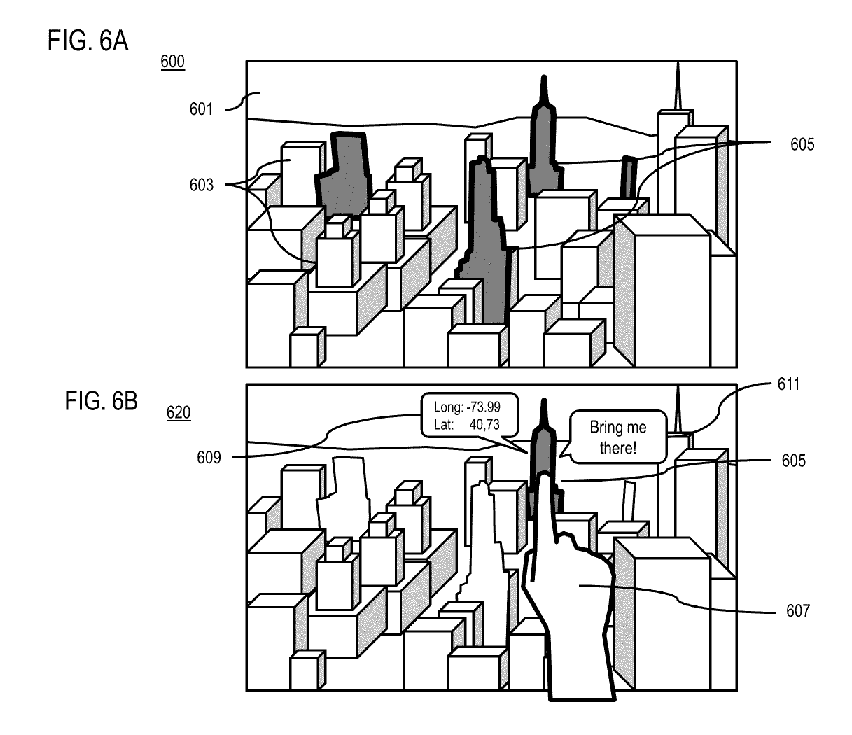

User interface 600 of FIG. 6A may be the rendering generated from the process of FIG. 4, wherein elements within a picture are highlighted to denote that they have associated location information. The image 601 of user interface includes elements 603. If selected, elements 603 may carry the same location information as that of image 601. In one embodiment, this location information may be geotagged information, such as where the image was taken. Elements 605, however, are highlighted. This highlighting may indicate that elements 605 have associated location information specific to the particular element. Therefore, the location information from an element 605 may be the address or coordinates of the element itself, rather than information regarding where the image was taken. One exemplary display includes elements 603 with landmarks as highlighted elements 605 embedded in image 601.

User interface 620 at FIG. 6B may be generated upon selection of one of the highlighted elements 605. As shown, in one embodiment, selection 607 may take place by touching or clicking on an element 605. In turn, the resultant display may include location information 609 as well as a prompt 611 to further process the location information.

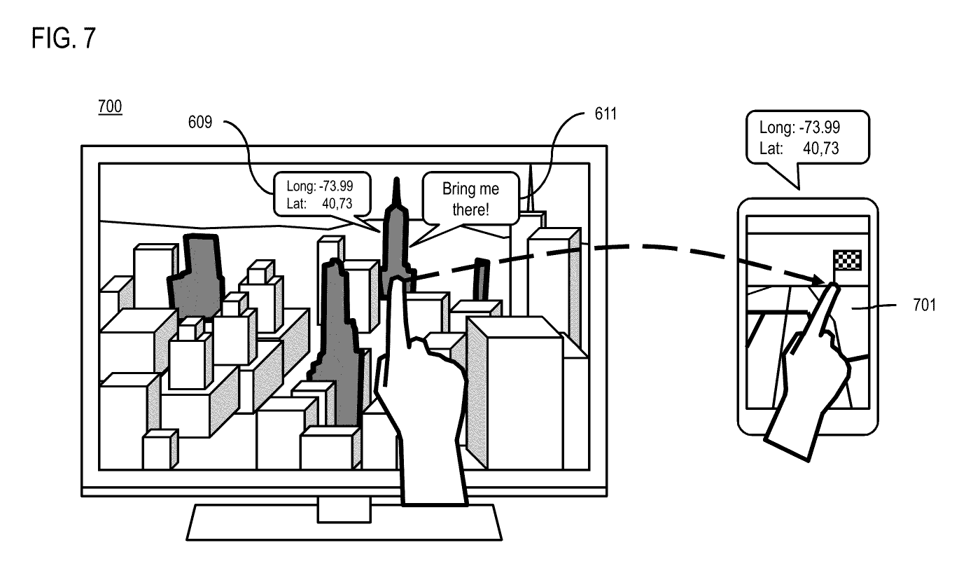

In a further embodiment, user interface 700 at FIG. 7 shows a response to prompt 611 where the system 100 may then process location information 609 and transfer location information 609 to another device 701. In one embodiment, further processing may include determining navigation information from location information 609. As shown, device 701 may be a portable device that may then navigate the user from his present destination to the site of location information 609. In one instance, device 701 may employ a GPS or other tool to determine navigation information. In another instance, device 701 may itself be a GPS.

The processes described herein for determining location information of elements within an image may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

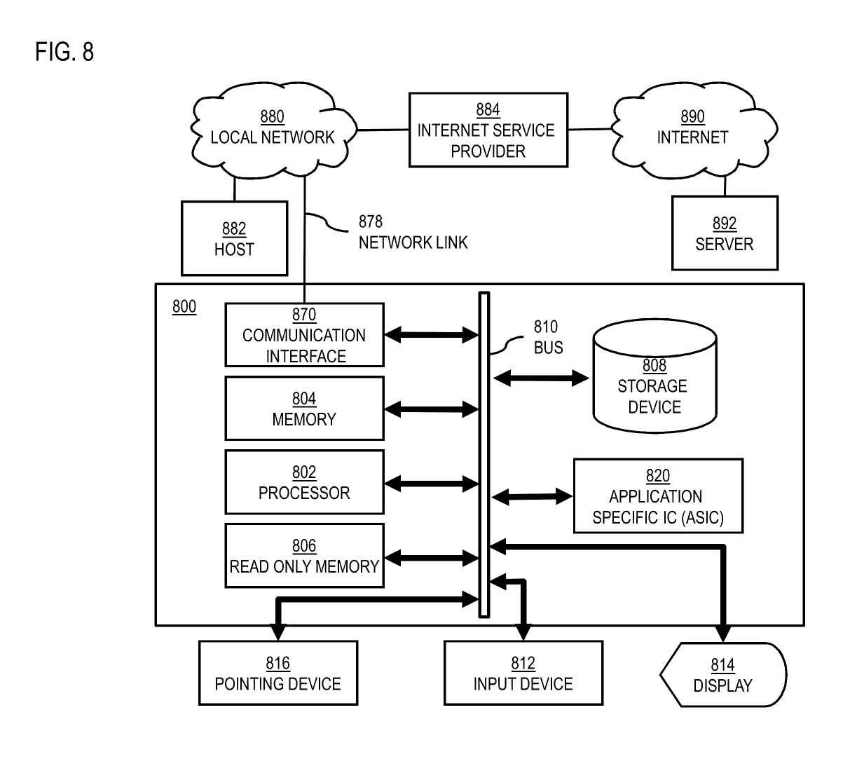

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to determining location information of elements within an image as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of determining location information of elements within an image

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to determining location information of elements within an image. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for determining location information of elements within an image. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for determining location information of elements within an image, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for determining location information of elements within an image to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to determine location information of elements within an image as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of determining location information of elements within an image associated with the availability of functions. Chip set or chip 900, or a portion thereof, constitutes a means for performing one or more steps of providing tag-based content installation.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to determine location information of elements within an image. The memory 905 also stores the data associated with or generated by the execution of the inventive steps.

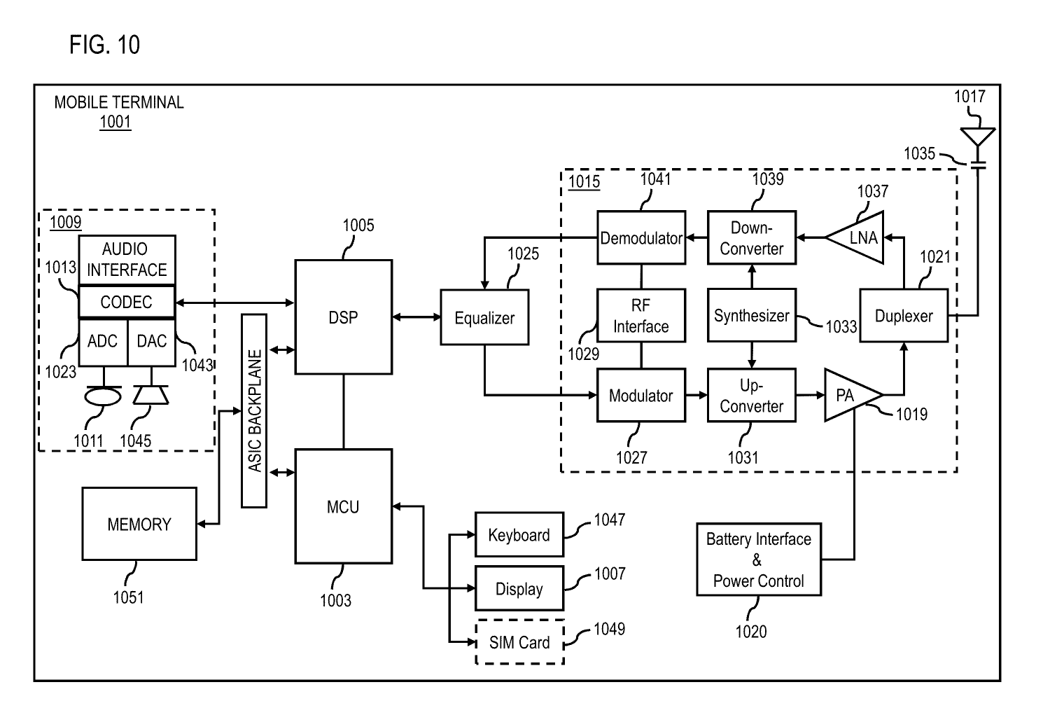

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of determining location information of elements within an image. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of determining location information of elements within an image. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to determine location information of elements within an image. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a selection of one or more elements depicted in one or more images;
an identification of the one or more elements, the one or more images, or a combination thereof; and
a transmission of the identified one or more elements, the identified one or more images, or a combination thereof for use by a device.

2. A method of claim 1, wherein the identified one or more elements, the identified one or more images, or a combination thereof is for use by a mapping application, a navigation application, a location-based application, or a combination thereof of the device.

3. A method of claim 1, wherein the identified one or more elements, the identified one or more images, or a combination thereof is for use as a destination, a waypoint, or a combination thereof of the device.

4. A method of claim 1, wherein the (1) data and/or (2) information and/or (3) at least one signal are further based, at least in part, on the following:
a processing of the one or more elements, the one or more images, or a combination to determine point-of-interest information, location information, descriptive information, or a combination thereof,
wherein the identification of the one or more elements, the one or more images, or a combination thereof is based, at least in part, on the point-of-interest information, the location information, the descriptive information, or a combination thereof.

5. A method of claim 1, wherein the (1) data and/or (2) information and/or (3) at least one signal are further based, at least in part, on the following:
a rendering of a user interface for enabling, at least in part, one or more touch-based interactions with respect to the one or more elements, the one or more images, or a combination thereof,
wherein the touch-based interactions are for causing, at least in part, the selection, the identification, the transmission, the use by the device, or a combination thereof.

6. A method comprising facilitating a processing of and/or processing (1) data and/or (2) information and/or (3) at least one signal, the (1) data and/or (2) information and/or (3) at least one signal based, at least in part, on the following:
a reception of one or more images, one or more elements depicted in the one or more images, or a combination thereof, wherein the one or more images, the one or more elements, or a combination thereof are associated with identification information; and
a usage of the one or more images, the one or more elements, the identification information, or a combination thereof in a mapping application, a navigation application, a location-based application, or a combination thereof.

7. A method of claim 6, wherein the (1) data and/or (2) information and/or (3) at least one signal are further based, at least in part, on the following:
at least one determination to cause, at least in part, the usage of the one or more images, the one or more elements, the identification information, or a combination thereof as one or more destinations, one or more waypoints, or a combination thereof of the mapping application, the navigation application, the location-based application, or a combination thereof.

8. A method of claim 6, wherein the identification information includes, at least in part, point-of-interest information, location information, descriptive information, or a combination thereof associated with the one or more images, the one or more elements, or a combination thereof.

9. A method of claim 6, wherein the (1) data and/or (2) information and/or (3) at least one signal are further based, at least in part, on the following:
a rendering of a user interface to present the one or more images, the one or more elements, the identification information, or a combination thereof,
wherein the usage in the mapping application, the navigation application, the location-based, application, or a combination thereof is based, at least in part, on interaction information associated with the user interface.

10. A method of claim 1, wherein the reception, the usage, or a combination thereof of the one or more images, the one or more elements, the identification information, or a combination thereof is at a video display device, a mobile device, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, a selection of one or more elements depicted in one or more images;
cause, at least in part, an identification of the one or more elements, the one or more images, or a combination thereof; and
cause, at least in part, a transmission of the identified one or more elements, the identified one or more images, or a combination thereof for use by a device.

12. An apparatus of claim 11, wherein the identified one or more elements, the identified one or more images, or a combination thereof is for use by a mapping application, a navigation application, a location-based application, or a combination thereof of the device.

13. An apparatus of claim 11, wherein the identified one or more elements, the identified one or more images, or a combination thereof is for use as a destination, a waypoint, or a combination thereof of the device.

14. An apparatus of claim 11, wherein the apparatus is further caused to:
process and/or facilitate a processing of the one or more elements, the one or more images, or a combination to determine point-of-interest information, location information, descriptive information, or a combination thereof,
wherein the identification of the one or more elements, the one or more images, or a combination thereof is based, at least in part, on the point-of-interest information, the location information, the descriptive information, or a combination thereof.

15. An apparatus of claim 11, wherein the apparatus is further caused to:
cause, at least in part, a rendering of a user interface for enabling, at least in part, one or more touch-based interactions with respect to the one or more elements, the one or more images, or a combination thereof,
wherein the touch-based interactions are for causing, at least in part, the selection, the identification, the transmission, the use by the device, or a combination thereof.

16. An apparatus comprising:
at least one processor; and
at least one memory including computer program code for one or more programs,
the at least one memory and the computer program code configured to, with the at least one processor, cause the apparatus to perform at least the following,
receive one or more images, one or more elements depicted in the one or more images, or a combination thereof, wherein the one or more images, the one or more elements, or a combination thereof are associated with identification information; and
cause, at least in part, a usage of the one or more images, the one or more elements, the identification information, or a combination thereof in a mapping application, a navigation application, a location-based application, or a combination thereof.

17. An apparatus of claim 16, wherein the apparatus is further caused to:
cause, at least in part, the usage of the one or more images, the one or more elements, the identification information, or a combination thereof as one or more destinations, one or more waypoints, or a combination thereof of the mapping application, the navigation application, the location-based application, or a combination thereof.

18. An apparatus of claim 16, wherein the identification information includes, at least in part, point-of-interest information, location information, descriptive information, or a combination thereof associated with the one or more images, the one or more elements, or a combination thereof.

19. An apparatus of claim 16, wherein the apparatus is further caused to:
cause, at least in part, a rendering of a user interface to present the one or more images, the one or more elements, the identification information, or a combination thereof,
wherein the usage in the mapping application, the navigation application, the location-based, application, or a combination thereof is based, at least in part, on interaction information associated with the user interface.

20. An apparatus of claim 16, wherein the reception, the usage, or a combination thereof of the one or more images, the one or more elements, the identification information, or a combination thereof is at a video display device, a mobile device, or a combination thereof.

21-56. (canceled)
